(19) United States
(12) Patent Application Publication
(10) Pub. No.: US 2026/0299079 A1
(43) Pub. Date: Oct. 1, 2026

(54) RADIO-WAVE-SENSOR SETTING ASSISTANCE DEVICE, RADIO-WAVE-SENSOR SETTING ASSISTANCE METHOD, AND NON-TRANSITORY STORAGE MEDIUM STORING COMPUTER PROGRAM

(71) Applicant: SUMITOMO ELECTRIC INDUSTRIES, LTD., Osaka (JP)

(72) Inventor: Shunya ASANO, Osaka-shi (JP)

(73) Assignee: SUMITOMO ELECTRIC INDUSTRIES, LTD., Osaka (JP)

(21) Appl. No.: 19/480,748

(22) PCT Filed: Jun. 18, 2024
(86) PCT No.: PCT/JP2024/021952

§ 371 Date: Oct. 31, 2025

(30) Foreign Application Priority Data
Jul. 14, 2023 (JP) 2023-115756

(51) Int. Cl. G01S 7/02; G01S 13/931

(52) U.S. Cl. CPC G01S 7/021; G01S 13/931

(57) ABSTRACT

A radio wave sensor setting assistance device includes: an acquisition unit that acquires the results of detecting, by a radio wave sensor, an object on a road; a first determination unit that determines, on the basis of the detection results acquired by the acquisition unit, an exclusion candidate area which is a candidate for an exclusion area to be excluded from a detection target of the radio wave sensor, and which is in a coordinate space set in the radio wave sensor; a display control unit that causes a display device to display the exclusion candidate area determined by the first determination unit; and a second determination unit that determines the exclusion candidate area displayed on the display device to be the exclusion area.

### TECHNICAL FIELD

The present disclosure relates to radio-wave-sensor setting assistance devices, radio-wave-sensor setting assistance methods, and computer programs. This application claims priority based on Japanese Patent Application No. 2023-115756, filed on Jul. 14, 2023, the entire disclosure of which is incorporated herein by reference.

### BACKGROUND ART

A radio wave sensor is disposed at a position where it can detect an object, such as a vehicle or a pedestrian, on a road or at an intersection for the purpose of monitoring traffic. For example, such a radio wave sensor for infrastructure (road facilities) is used for traffic volume measurement of vehicles traveling on a road and for detecting pedestrians on crosswalks. In order to use a radio wave sensor for monitoring traffic, it is necessary to set areas to be detected (referred to as “detection areas” hereinafter), such as roadways, lane lines, crosswalks, and sidewalks, in the coordinate system of the radio wave sensor (e.g., see Patent Literature 1).

### CITATION LIST

### Patent Literature

PTL 1: Japanese Unexamined Patent Application Publication No. 2017-090078

### SUMMARY OF INVENTION

A radio-wave-sensor setting assistance device according to an aspect of the present disclosure includes: an acquisition unit configured to acquire a detection result obtained by a radio wave sensor detecting an object on a road; a first determination unit configured to determine an exclusion candidate area in a coordinate space based on the detection result acquired by the acquisition unit, the exclusion candidate area being a candidate for an exclusion area to be excluded from a detection target of the radio wave sensor, the coordinate space being set in the radio wave sensor; a display control unit configured to cause a display device to display the exclusion candidate area determined by the first determination unit; and a second determination unit configured to determine, as the exclusion area, the exclusion candidate area displayed on the display device.

### BRIEF DESCRIPTION OF DRAWINGS

FIG. 1 is a diagram illustrating a usage example of an infrastructure radio wave sensor according to an embodiment.

FIG. 2 is a perspective view illustrating an example of the appearance structure of the infrastructure radio wave sensor according to the embodiment.

FIG. 3 is a diagram for explaining an example of setting a detection area in a sensor coordinate system.

FIG. 4 is a block diagram illustrating an example of a hardware configuration of a setting assistance device according to the embodiment.

FIG. 5 is a functional block diagram illustrating an example of functions of the setting assistance device according to the embodiment.

FIG. 6 is a diagram for explaining an example of determining an exclusion candidate area.

FIG. 7 is a diagram illustrating a first example of an exclusion area setting screen.

FIG. 8 is a diagram for explaining the movement of an icon on the exclusion area setting screen.

FIG. 9 is a diagram illustrating a second example of the exclusion area setting screen.

FIG. 10 is a diagram illustrating an example of correction values for the size, velocity range, and reception level range of each exclusion area.

FIG. 11 illustrates a third example of the exclusion area setting screen.

FIG. 12 is a flowchart illustrating an example of an exclusion-area setting assistance operation performed by the setting assistance device according to the embodiment.

FIG. 13 is a diagram illustrating a modification of the exclusion area setting screen.

### DETAILED DESCRIPTION

### Problems to be Solved by Present Disclosure

A road has stationary objects, such as vegetation, traffic signals, utility poles, and traffic signs. Such stationary objects are detected by a radio wave sensor and appear as noise in a detection result. Since noise affects the detection accuracy, an area having a stationary object is excluded from the detection target and is set as an exclusion area in the radio wave sensor. However, the process for setting an exclusion area is extremely complicated.

### Advantageous Effects of Present Disclosure

The present disclosure makes it possible to assist in setting an exclusion area to be excluded from a detection target for a radio wave sensor.

### General Outline of Embodiment of Present Disclosure

The general outline of an embodiment of the present disclosure will be listed below.
(1) A radio-wave-sensor setting assistance device according to the embodiment includes: an acquisition unit configured to acquire a detection result obtained by a radio wave sensor detecting an object on a road; a first determination unit configured to determine an exclusion candidate area in a coordinate space based on the detection result acquired by the acquisition unit, the exclusion candidate area being a candidate for an exclusion area to be excluded from a detection target of the radio wave sensor, the coordinate space being set in the radio wave sensor; a display control unit configured to cause a display device to display the exclusion candidate area determined by the first determination unit; and a second determination unit configured to determine, as the exclusion area, the exclusion candidate area displayed on the display device. This makes it possible to assist in setting the exclusion area in the radio wave sensor.
(2) In (1) above, the second determination unit may determine a type of the exclusion area. This makes it possible to determine the exclusion area according to the type of object (e.g., vegetation, traffic signal, utility pole, ornamental tree, guardrail, or traffic sign) to be excluded from the detection target.
(3) In (2) above, the type may be a type designated by a user. This makes it possible to determine an accurate type of exclusion area designated by the user as the exclusion area.
(4) In (3) above, the display control unit may cause the display device to display a plurality of images respectively corresponding to a plurality of types of exclusion areas, and the second determination unit may receive designation of any of the types with respect to the exclusion area corresponding to the exclusion candidate area in response to an operation by the user for disposing any of the images in the exclusion candidate area. Accordingly, by disposing the image of the type of exclusion area to be allocated to the exclusion candidate area in the exclusion candidate area, the user can readily designate the type with respect to the exclusion area.
(5) In any one of (2) to (4) above, the second determination unit may determine a size of the exclusion area in accordance with the type of the exclusion area. This makes it possible to determine an exclusion area having an appropriate size in accordance with the type of exclusion area.
(6) In (5) above, the second determination unit may determine the size of the exclusion area corresponding to the exclusion candidate area by correcting an initial size allocated to the exclusion candidate area based on a predetermined correction value for the type. Accordingly, by presetting the correction value for each type, an exclusion area having an appropriate size can be determined in accordance with the type of exclusion area.
(7) In any one of (1) to (6) above, the second determination unit may determine, in association with the exclusion area, at least one of a velocity range of an object to be excluded from the detection target and a radio wave reception level range of the radio wave sensor from the object to be excluded from the detection target. By setting such an exclusion area, the radio wave sensor can use not only the position of the object to be detected but also at least one of the detection velocity and the radio wave reception level to accurately determine whether the detected object is an object to be excluded from the detection target or an object (vehicle or pedestrian) to be detected.
(8) In (7) above, the second determination unit may determine a magnitude of at least one of a velocity of the object and a radio wave reception level of the radio wave sensor from the object in accordance with a type determined with respect to the exclusion area. This makes it possible to appropriately determine the magnitude of at least one of the velocity range and the radio wave reception level in accordance with the type of exclusion area.
(9) In any one of (1) to (8) above, the first determination unit may determine a position of the exclusion candidate area within a set area set based on a detection area set in the coordinate space, the detection area corresponding to a specific area on the road and to be detected by the radio wave sensor. It is not necessary to provide an exclusion area at a position located away from the detection area by a certain distance or more. The above configuration makes it possible to determine the position of the exclusion area within the set area, which is an appropriate area for setting the exclusion area.
(10) In any one of (1) to (9) above, a deletion unit configured to delete the exclusion candidate area in response to a command from a user may be further included. Accordingly, the user can delete an exclusion candidate area not suitable as an exclusion area.
(11) In any one of (1) to (10) above, the display control unit may cause the display device to display the exclusion candidate area together with a detection area set in the coordinate space, the detection area corresponding to a specific area on the road and to be detected by the radio wave sensor. Accordingly, the user can readily confirm, from the position of the exclusion candidate area relative to the detection area, which object in the real space the exclusion candidate area corresponds to.
(12) In any of (1) to (11) above, the acquisition unit may acquire the detection result obtained by the radio wave sensor detecting the object on the road within a certain detection period, the detection result may indicate reflection points, on the object, of a radio wave radiated from the radio wave sensor, and the first determination unit may group all of the reflection points detected in the detection period based on positions of the reflection points in the coordinate space, and determine the exclusion candidate area at a position of each group. When the radio wave sensor continuously performs object detection within the certain detection period, reflection points are continuously detected from a stationary object within the detection period. Therefore, each group is formed by multiple reflection points located close to each other, and each group corresponds to one stationary object. This makes it possible to accurately determine the position of each stationary object as an exclusion area.
(13) A radio-wave-sensor setting assistance method according to this embodiment includes: acquiring a detection result obtained by a radio wave sensor detecting an object on a road; determining an exclusion candidate area in a coordinate space based on the acquired detection result, the exclusion candidate area being a candidate for an exclusion area to be excluded from a detection target of the radio wave sensor, the coordinate space being set in the radio wave sensor; causing a display device to display the determined exclusion candidate area; and determining, as the exclusion area, the exclusion candidate area displayed on the display device. This makes it possible to assist in setting the exclusion area in the radio wave sensor.
(14) A computer program according to this embodiment is a computer program for assisting in setting a radio wave sensor configured to detect an object on a road and causes a computer to execute a process including: acquiring a detection result obtained by the radio wave sensor detecting the object on the road; determining an exclusion candidate area in a coordinate space based on the acquired detection result, the exclusion candidate area being a candidate for an exclusion area to be excluded from a detection target of the radio wave sensor, the coordinate space being set in the radio wave sensor; causing a display device to display the determined exclusion candidate area; and determining, as the exclusion area, the exclusion candidate area displayed on the display device. This makes it possible to assist in setting the exclusion area in the radio wave sensor.

The present disclosure can be realized not only as the radio-wave-sensor setting assistance device including the characteristic components described above, the radio-wave-sensor setting assistance method including the characteristic processes as steps in the setting assistance device, and the computer program for causing the setting assistance device to execute the characteristic processes, but also as a semiconductor integrated circuit including a part of or the entirety of the radio-wave-sensor setting assistance device, or as a system partially including the radio-wave-sensor setting assistance device.

### Details of Embodiment of Present Disclosure

An embodiment of the present disclosure will be described in detail below with reference to the drawings. At least some of the embodiment to be described below may be arbitrarily combined.

### 1. Infrastructure Radio Wave Sensor

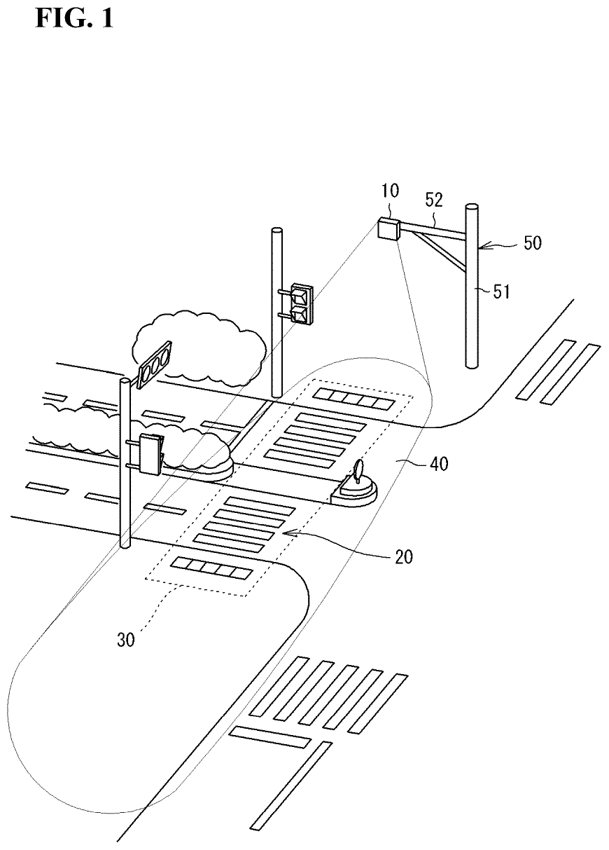

FIG. 1 is a diagram illustrating a usage example of an infrastructure radio wave sensor according to an embodiment. An infrastructure radio wave sensor 10 according to this embodiment is a radio wave radar for monitoring traffic and detects a pedestrian at a crosswalk 20. The infrastructure radio wave sensor 10 is, for example, a millimeter wave radar.

The infrastructure radio wave sensor 10 is attached to a structural object 50 provided on a road. The structural object 50 has a height of several meters, and the infrastructure radio wave sensor 10 is installed at a height of several meters above the ground. The structural object 50 includes, for example, a pole 51 and an arm 52 provided near the upper end of the pole 51, and the infrastructure radio wave sensor 10 is attached to the arm 52.

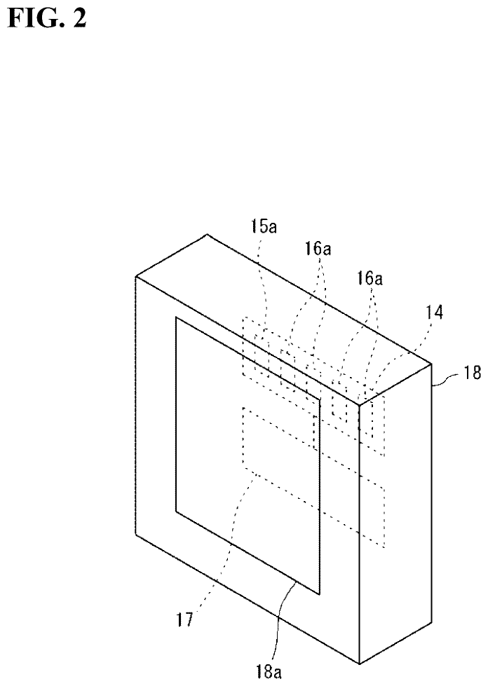

The infrastructure radio wave sensor 10 radiates a radio wave (millimeter wave) onto the crosswalk 20 and receives a reflected wave therefrom, so as to detect an object (e.g., a pedestrian and/or a bicycle) on the crosswalk 20. In detail, the infrastructure radio wave sensor 10 is disposed such that a straight line (also referred to as “projection center axis” hereinafter) obtained by projecting a normal line of a transmitting-receiving surface 18a (see FIG. 2), which transmits and receives a radio wave, from the center of the transmitting-receiving surface 18a to the ground surface in the vertical direction extends along the crosswalk 20. The infrastructure radio wave sensor 10 can detect the distance from the infrastructure radio wave sensor 10 to the object, the velocity of the object (i.e., the velocity in a direction of a straight line connecting the infrastructure radio wave sensor 10 and the object, and also referred to as “line-of-sight velocity” hereinafter), and the horizontal angle (azimuth angle) of the position where the object exists relative to the projection center axis.

In the infrastructure radio wave sensor 10, a detection area 30 is set to serve as a range on the road for detecting an object. The detection area 30 is set as a part of a radio wave irradiation area 40 of the infrastructure radio wave sensor 10. Specifically, the radio wave irradiation area 40 covers the detection area 30. The detection area 30 is, for example, an area including the entire crosswalk 20. The radio wave irradiation area 40 is a range in which the infrastructure radio wave sensor 10 can detect an object based on a reflected wave from the object occurring as a result of the object reflecting a radio wave radiated from the infrastructure radio wave sensor 10, and does not include a range in which the infrastructure radio wave sensor 10 cannot detect the object even if a radio wave can be radiated therefrom. However, the radio wave irradiation area 40 is not limited to this, and may be an entire range onto which the infrastructure radio wave sensor 10 can radiate a radio wave.

For example, the infrastructure radio wave sensor 10 is used for traffic volume measurement of pedestrians and bicycles (including passengers, and will both be simply referred to as “pedestrians” hereinafter) passing through the crosswalk 20, or for controlling a traffic signal set at the crosswalk 20. The infrastructure radio wave sensor 10 is demanded to detect not only a pedestrian on the crosswalk but also a pedestrian waiting for crossing on a sidewalk adjacent to the crosswalk 20. Therefore, for example, the detection area 30 includes not only an area of the crosswalk 20 but also an area where a pedestrian waits on a sidewalk for crossing. Specifically, the detection area 30 is an area extended from the crosswalk 20 toward the opposite sides of the crosswalk 20 in the longitudinal direction thereof (i.e., a direction in which a pedestrian passes along the crosswalk).

FIG. 2 is a perspective view illustrating an example of the appearance structure of the infrastructure radio wave sensor 10 according to the embodiment. As illustrated in FIG. 2, the infrastructure radio wave sensor 10 includes a housing 18 having the transmitting-receiving surface 18a, which transmits and receives a radio wave, at one surface thereof. The housing 18 accommodates a transmitter-receiver 14 and a detection circuit 17. The transmitter-receiver 14 includes a transmitting antenna 15a and multiple (e.g., four) receiving antennas 16a. The infrastructure radio wave sensor 10 transmits a modulation wave as a radio wave from the transmitting antenna 15a via the transmitting-receiving surface 18a. The modulation wave strikes an object and is reflected, and the reflected wave is received by the receiving antennas 16a. The transmitter-receiver 14 and the detection circuit 17 perform signal processing on a transmitted wave signal and a received wave signal, thereby detecting the distance to the object, the line-of-sight velocity of the object, and the azimuth angle at which the object exists.

In the infrastructure radio wave sensor 10, a coordinate space is set for identifying the position of an object. The coordinate space set in the infrastructure radio wave sensor 10 will also be referred to as “sensor coordinate space” hereinafter. The sensor coordinate space is a coordinate space unique to the infrastructure radio wave sensor 10.

In the infrastructure radio wave sensor 10, the detection area 30 is set in the sensor coordinate space for accurately detecting an object on the crosswalk 20.

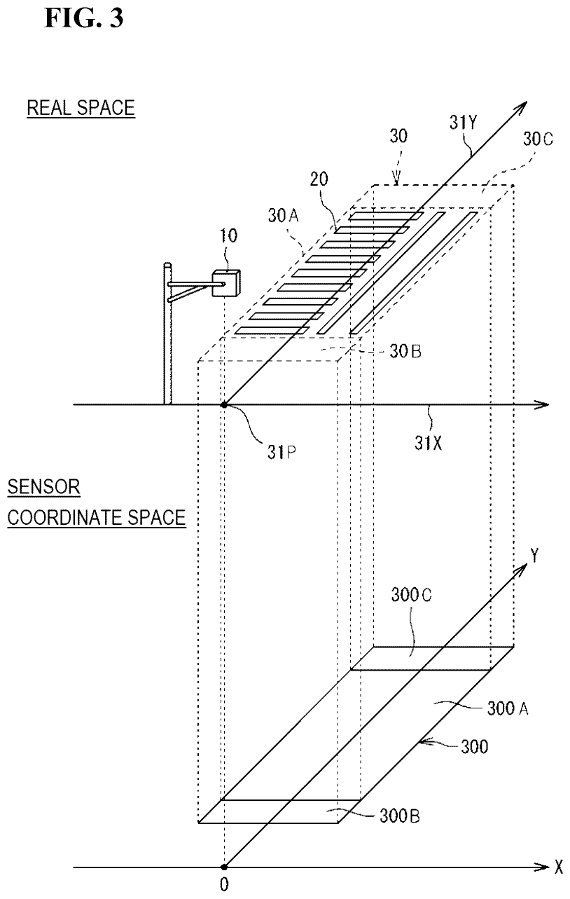

FIG. 3 is a diagram for explaining an example of setting the detection area in a sensor coordinate system.

In FIG. 3, a point denoted by reference sign 31P is a point on the ground surface obtained by projecting the installation position of the infrastructure radio wave sensor 10 vertically downward. A straight line denoted by reference sign 31Y is the projection center axis, and a straight line denoted by reference sign 31X is a straight line on the ground surface intersecting with the projection center axis 31Y at the point 31P.

For example, the sensor coordinate space is a virtual coordinate space set in the infrastructure radio wave sensor 10 and is a two-dimensional coordinate space corresponding to the ground surface. The sensor coordinate space is defined by an X axis and a Y axis. An origin point O of the sensor coordinate space corresponds to the point 31P in actuality. The Y axis of the sensor coordinate space corresponds to the projection center axis 31Y in actuality. The X axis of the sensor coordinate space corresponds to the straight line 31X in actuality.

In the infrastructure radio wave sensor 10, a virtual detection area 300 corresponding to the detection area 30 in real space is set in the sensor coordinate space. The detection area 30 is, for example, an area including the crosswalk 20.

The detection area 30 is divided into a zebra zone 30A as an area of the crosswalk 20, and waiting zones 30B and 30C provided at opposite ends of the zebra zone 30A. Each of the waiting zones 30B and 30C is extended in the longitudinal direction (i.e., the direction of the projection center axis 31Y) from the zebra zone 30A and is a sidewalk area where a pedestrian waits for a traffic signal.

The detection area 300 in the sensor coordinate space is divided into a zebra zone 300A and waiting zones 300B and 300C. The zebra zone 300A corresponds to the zebra zone 30A in real space. The waiting zone 300B corresponds to the waiting zone 30B in real space, and the waiting zone 300C corresponds to the waiting zone 30C in real space.

Furthermore, in the infrastructure radio wave sensor 10, an exclusion area to be excluded from the detection target needs to be set for suppressing noise occurring due to detection of stationary objects, such as vegetation, an ornamental tree, a utility pole, a traffic signal, a guardrail, and a traffic sign. In this embodiment, a setting assistance device 100 assists a user (operator) in setting an exclusion area in the sensor coordinate space of the infrastructure radio wave sensor 10.

### 2. Configuration of Setting Assistance Device

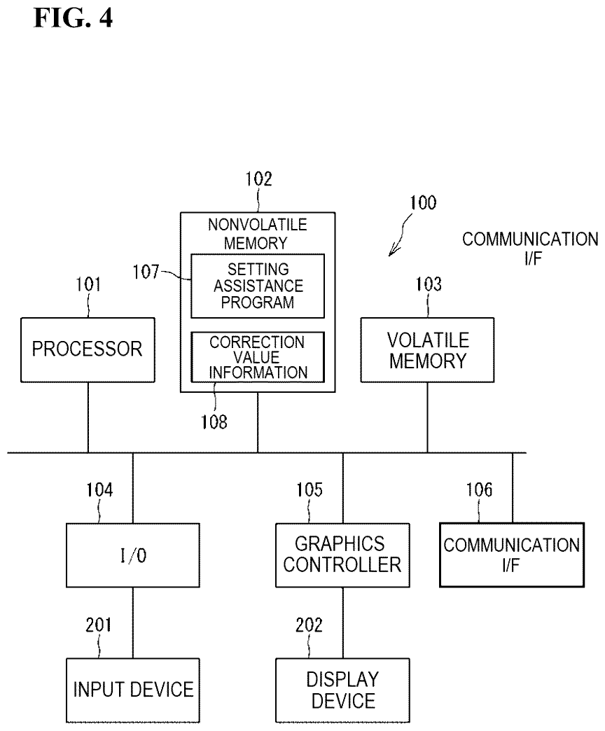

FIG. 4 is a block diagram illustrating an example of a hardware configuration of the setting assistance device according to the embodiment. The setting assistance device 100 according to this embodiment is to be used by the user who sets the detection area 30 of the infrastructure radio wave sensor 10. The setting assistance device 100 includes a processor 101, a nonvolatile memory 102, a volatile memory 103, an input-output interface 104, a graphics controller 105, and a communication interface 106. The setting assistance device 100 further includes an input device 201 and a display device 202. At least one of the input device 201 and the display device 202 may be an external device connected to the setting assistance device 100.

The volatile memory 103 is a semiconductor memory, such as an SRAM (static random access memory) or a DRAM (dynamic random access memory). The nonvolatile memory 102 is, for example, a flash memory, a hard disk, a ROM (read only memory), or the like. The nonvolatile memory 102 has stored therein a setting assistance program 107 as a computer program as well as data to be used for executing the setting assistance program 107. The functions of the setting assistance device 100 are exhibited by the processor 101 executing the setting assistance program 107. The setting assistance program 107 may be stored in a recording medium, such as a flash memory, a ROM, or a CD-ROM. The processor 101 assists the user in setting an exclusion area for the infrastructure radio wave sensor 10 in accordance with the setting assistance program 107.

The processor 101 is, for example, a CPU (central processing unit). However, the processor 101 is not limited to a CPU. The processor 101 may be a GPU (graphics processing unit). For example, the processor 101 may be an ASIC (application specific integrated circuit) or a programmable logic device, such as an FPGA (field programmable gate array). In this case, the ASIC or the programmable logic device is capable of executing a process identical to the setting assistance program 107.

For example, the input device 201 includes a keyboard and a pointing device, such as a mouse. The input device 201 may be a capacitive or pressure-sensitive touchpad overlaid on a screen of the display device 202. The input device 201 is used for inputting data to the setting assistance device 100. The input-output interface 104 is connected to the input device 201. The input-output interface 104 receives input data from the input device 201 and supplies the received data to the processor 101.

The display device 202 includes, for example, a liquid crystal panel or an OEL (organic electroluminescence) panel. The display device 202 can display text or graphic information. The graphics controller 105 is connected to the display device 202 and controls the display on the display device 202. The graphics controller 105 includes, for example, a GPU and a VRAM (video RAM), causes the VRAM to retain data to be displayed on the display device 202, and periodically reads one frame of video data from the VRAM, thereby generating a video signal. The generated video signal is output to the display device 202, so that video is displayed on the display device 202. The function of the graphics controller 105 may be included in the processor 101. A partial area of the volatile memory 103 may be used as the VRAM.

The communication interface 106 can communicate with an external device. For example, the communication interface 106 is connected to the infrastructure radio wave sensor 10 by a communication cable and can communicate with the infrastructure radio wave sensor 10. The communication interface 106 may be a wireless communication interface and may wirelessly communicate with the infrastructure radio wave sensor 10.

### 3. Function of Setting Assistance Device

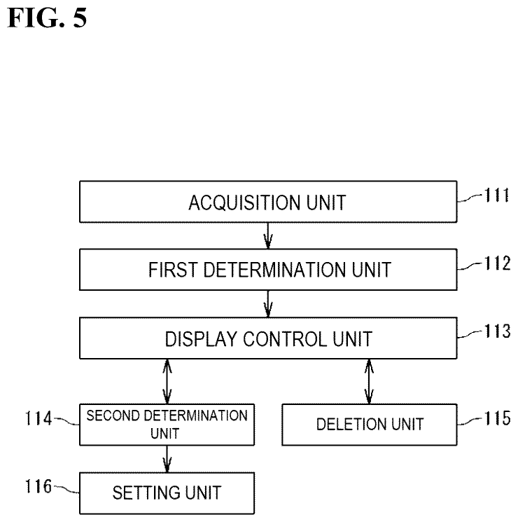

FIG. 5 is a functional block diagram illustrating an example of functions of the setting assistance device according to the embodiment. The processor 101 executes the setting assistance program 107, so that the setting assistance device 100 functions as an acquisition unit 111, a first determination unit 112, a display control unit 113, a second determination unit 114, a deletion unit 115, and a setting unit 116.

The infrastructure radio wave sensor 10 can be set between two modes, namely, a setting mode and an operation mode. The setting mode is for setting an exclusion area for the infrastructure radio wave sensor 10. The operation mode involves detecting an object for monitoring traffic after the exclusion area is set.

When an exclusion area is to be set, the infrastructure radio wave sensor 10 is activated in the setting mode. The setting assistance device 100 communicates with the infrastructure radio wave sensor 10 operating in the setting mode, so as to set an exclusion area.

In the setting mode, the infrastructure radio wave sensor 10 detects an object for setting an exclusion area. The infrastructure radio wave sensor 10 radiates a radio wave from the transmitting antenna 15a, and receives a reflected wave of the radio wave via the receiving antenna 16a. The infrastructure radio wave sensor 10 detects the position of the object based on the reflected wave received by the receiving antenna 16a.

In detail, the transmitting antenna 15a transmits a transmission signal that is a modulation wave. The transmission signal from the transmitting antenna 15a strikes the object and is reflected. The receiving antenna 16a receives a reflected wave from the object. The detection circuit 17 combines the transmitted modulation wave signal and the received reflected wave signal, so as to generate an intermediate frequency signal (referred to as “IF signal” hereinafter). The detection circuit 17 performs a fast Fourier transform (FFT) on the IF signal, so as to acquire information about the distance, velocity, and azimuth angle.

For example, based on the acquired information about the distance, velocity, and azimuth angle, the detection circuit 17 identifies the position (coordinate value) of a peak point of the reflected wave (i.e., a maximum point of the signal level of the reflected wave, which is also referred to as “reflection point” hereinafter) in the sensor coordinate space. The detection circuit 17 outputs a detection result including the coordinate value of the reflection point.

The acquisition unit 111 acquires a detection result obtained by the infrastructure radio wave sensor 10 detecting the object on the road.

In one specific example, the infrastructure radio wave sensor 10 in the setting mode detects the object on the road within a certain detection period. For example, the detection period is a period ranging from one second to one hour.

The infrastructure radio wave sensor 10 continuously detects the position of the reflection point during the detection period. The detection result output from the infrastructure radio wave sensor 10 includes coordinate values of all reflection points detected during the detection period. The acquisition unit 111 acquires the detection result obtained by the infrastructure radio wave sensor 10 detecting the object within the detection period.

Based on the detection result acquired by the acquisition unit 111, the first determination unit 112 determines, in the sensor coordinate space, an exclusion candidate area as a candidate for an exclusion area to be excluded from the detection target for the infrastructure radio wave sensor 10.

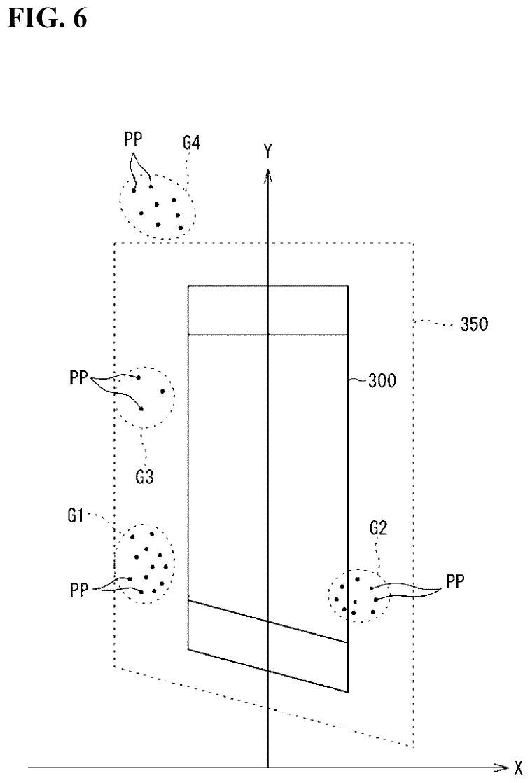

FIG. 6 is a diagram for explaining an example of determining an exclusion candidate area.

A radio wave radiated from the infrastructure radio wave sensor 10 may sometimes be reflected simultaneously by multiple objects. However, in a single object, the reflection intensity of the radio wave varies depending on the location. Therefore, multiple reflection points may sometimes be detected from a single object.

The first determination unit 112 groups reflection points on the same object. In FIG. 6, reflection points PP appear concentrated at four locations in the sensor coordinate space. For example, based on the distance between the reflection points PP, the first determination unit 112 groups (clusters) the reflection points PP. Specifically, multiple reflection points PP that are close to each other form a single group. In FIG. 6, four groups, namely, groups G1, G2, G3, and G4, are formed. For example, the group G1 is a group constituted by multiple reflection points PP from vegetation. The group G2 is a group constituted by multiple reflection points PP from a utility pole. The group G3 is a group constituted not by reflection points PP from a specific object but by erroneously-detected reflection points PP. The group G4 is a group constituted by multiple reflection points PP from an ornamental tree.

The first determination unit 112 determines an exclusion candidate area at the position of each group formed by grouping in the sensor coordinate space. In a more specific example, the first determination unit 112 determines the position of each exclusion candidate area within a set area 350. The set area 350 is an area set based on the detection area 300 in the sensor coordinate space. For example, the set area 350 is an area obtained by extending outer edges of the detection area 300. For example, if the outer edges of the detection area 300 form a polygonal shape as illustrated in FIG. 6, the set area 350 has a polygonal shape that is larger than that of the detection area 300 and whose edges have been shifted outward by predetermined distances.

In the example in FIG. 6, the groups G1, G2, and G3 are inside the set area 350, whereas the group G4 is outside the set area 350. Therefore, exclusion candidate areas are disposed at the respective positions of the three groups G1, G2, and G3. An exclusion candidate area is not disposed at the position of the group G4.

Referring back to FIG. 5, the display control unit 113 causes the display device 202 to display the exclusion candidate areas determined by the first determination unit 112.

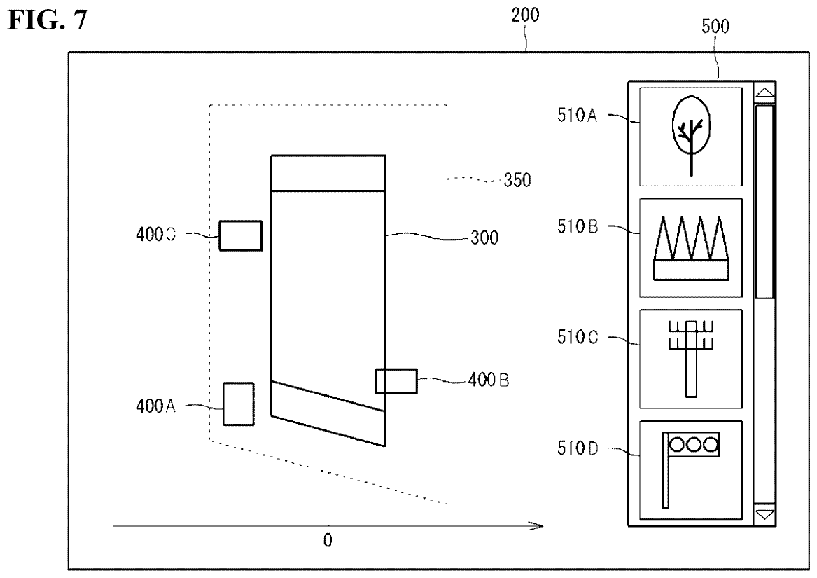

For example, the display device 202 displays an exclusion area setting screen in which the exclusion candidate areas are disposed in the sensor coordinate space. FIG. 7 is a diagram illustrating a first example of the exclusion area setting screen.

The display control unit 113 causes the display device 202 to display the exclusion candidate areas together with the detection area 300. Specifically, on an exclusion area setting screen 200, the detection area 300 and exclusion candidate areas 400A, 400B, and 400C are displayed simultaneously in the sensor coordinate space defined by the X axis and the Y axis. In the example in FIG. 7, the exclusion candidate area 400A corresponds to the group G1, the exclusion candidate area 400B corresponds to the group G2, and the exclusion candidate area 400C corresponds to the group G3.

The detection area 300 and the exclusion candidate areas 400A, 400B, and 400C are displayed simultaneously so that the user can ascertain the positional relationship between each of the exclusion candidate areas 400A, 400B, and 400C and the detection area 300. For example, by checking the positional relationship between each of the exclusion candidate areas 400A, 400B, and 400C and the detection area 300 against the positional relationship between each stationary object and the detection area 30 (or the crosswalk 20) in real space, the user can recognize which of the exclusion candidate areas 400A, 400B, and 400C corresponds to which of the stationary objects. In the example in FIG. 7, the user can recognize that the exclusion candidate area 400A corresponds to vegetation and the exclusion candidate area 400B corresponds to a utility pole. Similarly, the user can recognize that there is no stationary object that corresponds to the exclusion candidate area 400C.

Referring back to FIG. 5, the second determination unit 114 determines the exclusion candidate areas 400A and 400B, which are displayed on the display device 202, as exclusion areas.

For example, the second determination unit 114 determines the type of each exclusion area. The type of exclusion area is the type of object located in the exclusion area. The type of exclusion area is, for example, vegetation, an ornamental tree, a utility pole, a traffic signal, a guardrail, or a traffic sign. Accordingly, the user can identify whether an exclusion area has been determined for excluding which type of stationary object from the detection target.

In one specific example, the user can use the input device 201 to designate the type of exclusion area. The second determination unit 114 determines a preliminarily programmed type for the exclusion area.

The display control unit 113 causes the display device 202 to display multiple images (icons) respectively corresponding to multiple types of exclusion areas. Referring to FIG. 7, the exclusion area setting screen 200 is provided with, for example, an icon display area 500. The icon display area 500 has disposed therein multiple icons 510A, 510B, 510C, and 510D. The multiple icons 510A, 510B, 510C, and 510D respectively correspond to the multiple types of exclusion areas. Specifically, in the example in FIG. 7, the icon 510A corresponds to vegetation. The icon 510A includes an image of the vegetation. The icon 510B corresponds to an ornamental tree. The icon 510B includes an image of the ornamental tree. The icon 510C corresponds to a utility pole. The icon 510C includes an image of the utility pole. The icon 510D corresponds to a traffic signal. The icon 510D includes an image of the traffic signal. By scrolling the icon display area 500, icons corresponding to types of exclusion areas (a guardrail and a traffic sign) other than the above can also be displayed.

For example, in response to a user operation involving disposing the icon 510A, 510B, 510C, or 510D in the exclusion candidate area 400A, 400B, or 400C, the second determination unit 114 receives designation of the type corresponding to the icon to the exclusion area corresponding to the exclusion candidate area 400A, 400B, or 400C. Specifically, the icons 510A, 510B, 510C, and 510D can be moved within the screen by, for example, a dragging operation.

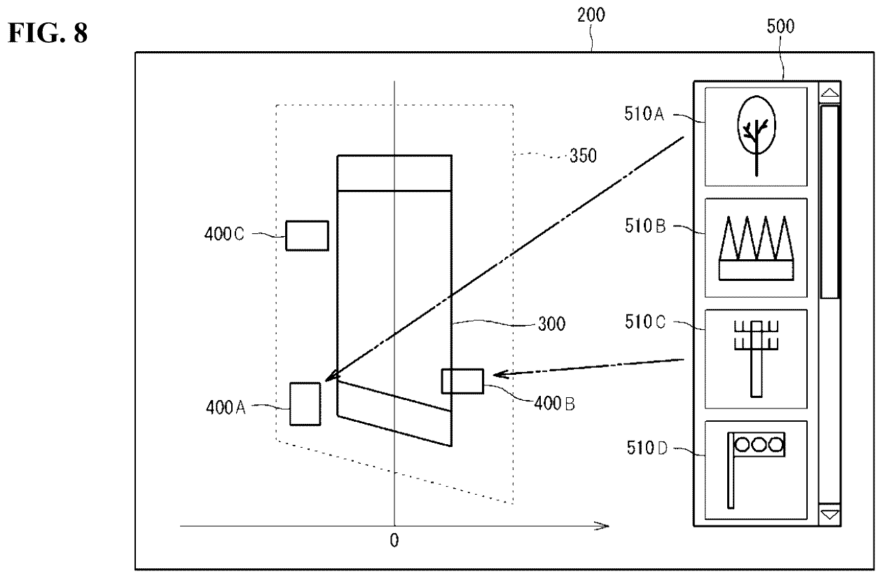

FIG. 8 is a diagram for explaining the movement of an icon on the exclusion area setting screen. By a drag-and-drop operation, the user moves any of the icons 510A, 510B, 510C, and 510D from the icon display area 500 to any of the exclusion candidate areas 400A, 400B, and 400C. In the example in FIG. 8, the icon 510A of the vegetation is disposed in the exclusion candidate area 400A corresponding to the vegetation. The icon 510C of the utility pole is disposed in the exclusion candidate area 400B corresponding to the utility pole. An icon is not disposed in the exclusion candidate area 400C that does not correspond to a specific stationary object.

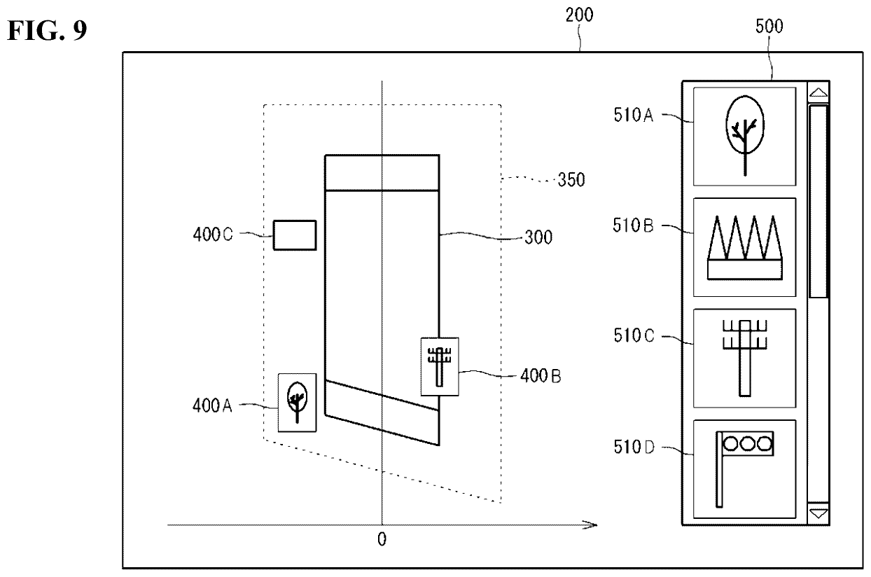

FIG. 9 is a diagram illustrating a second example of the exclusion area setting screen. The exclusion area setting screen 200 illustrated in FIG. 9 corresponds to a case where the icon 510A is disposed in the exclusion candidate area 400A and the icon 510C is disposed in the exclusion candidate area 400B.

With the icons 510A and 510C being disposed at the positions of the exclusion candidate areas 400A and 400B where the icons 510A and 510C are disposed, exclusion areas 410A and 410B of types corresponding to the icons 510A and 510C are determined. In other words, the exclusion candidate areas 400A and 400B where the icons 510A and 510C are disposed change into the exclusion areas 410A and 410B.

Referring back to FIG. 5, for example, the second determination unit 114 determines the size of each exclusion area in accordance with the type of exclusion area. Specifically, in the example in FIG. 9, the type of exclusion area 410A determined at the position of the exclusion candidate area 400A is set to “vegetation”. The exclusion area 410A is set to a size corresponding to the vegetation. The type of exclusion area 410B determined at the position of the exclusion candidate area 400B is set to “utility pole”. The exclusion area 410B is set to a size corresponding to the utility pole. The infrastructure radio wave sensor 10 does not detect an object within the exclusion area having the determined size. In other words, an object (reflection point) detected within the exclusion area is excluded from the detection result.

For example, the second determination unit 114 determines a velocity range of an object to be excluded from the detection target in association with an exclusion area. Specifically, in the example in FIG. 9, the velocity range of the exclusion area 410A is set to a value corresponding to the vegetation. The velocity range of the exclusion area 410B is set to a value corresponding to the utility pole. In the infrastructure radio wave sensor 10, an object within the velocity range in which the line-of-sight velocity is set is not detected within an exclusion area. In other words, in the exclusion area, if the line-of-sight velocity of a detected object (reflection point) is within the velocity range of the exclusion area, the object is excluded from the detection result.

For example, the second determination unit 114 determines a radio wave reception level range (also referred to as “reception level range” hereinafter) of an object to be excluded from the detection target in association with an exclusion area. Specifically, in the example in FIG. 9, the reception level range of the exclusion area 410A is set to a value corresponding to the vegetation. The reception level range of the exclusion area 410B is set to a value corresponding to the utility pole. In the infrastructure radio wave sensor 10, an object within the reception level range in which the radio wave reception level is set is not detected within an exclusion area. In other words, in the exclusion area, if the radio reception level from a detected object (reflection point) is within the reception level range of the exclusion area, the object is excluded from the detection result.

For example, the second determination unit 114 may correct an initial size allocated to an exclusion candidate area by using a predetermined correction value for the type of exclusion area, thereby determining the size of the exclusion area corresponding to the exclusion candidate area.

For example, the second determination unit 114 may correct an initial velocity range allocated to an exclusion candidate area by using a predetermined correction value for the type of exclusion area, thereby determining the velocity range of the exclusion area corresponding to the exclusion candidate area.

For example, the second determination unit 114 may correct an initial reception level range allocated to an exclusion candidate area by using a predetermined correction value for the type of exclusion area, thereby determining the reception level range of the exclusion area corresponding to the exclusion candidate area.

For example, a preset initial size, a preset velocity range, and a preset reception level range are allocated to each of the exclusion candidate areas 400A, 400B, and 400C. The preset initial size, the preset velocity range, and the preset reception level range are, for example, fixed values. Alternatively, the preset initial size, the preset velocity range, and the preset reception level range allocated to each of the exclusion candidate areas 400A, 400B, and 400C may be determined based on at least one of the size of each of the groups G1, G2, and G3 determined in the exclusion candidate areas 400A, 400B, and 400C, the number of reflection points, and the radio wave reception level of the reflection point.

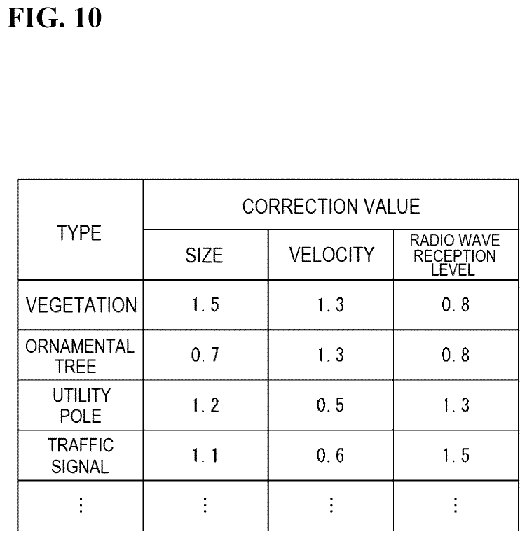

Correction value information 108 including correction values for the size, velocity range, and reception level range of each exclusion area is stored in, for example, the nonvolatile memory 102 (see FIG. 4). FIG. 10 is a diagram illustrating an example of correction values for the size, velocity range, and reception level range of each exclusion area.

In the example in FIG. 10, the correction values for the size, velocity (velocity range), and radio wave reception level (reception level range) are set in the correction value information 108 for each type of exclusion area. For example, the size of a range in which a reflection point detected from a stationary object occurs is correlated with the size and shape of the stationary object. Therefore, the correction value for the size of the exclusion area is set based on, for example, the size and shape of the stationary object. For example, the line-of-sight velocity detected from the stationary object is correlated with the material (e.g., material flexibility) and structure (e.g., whether fine sections exist) of the stationary object. Therefore, the correction value for the velocity range of the exclusion area is set based on, for example, the material and structure of the stationary object. For example, the reception level of a reflected wave from the stationary object is correlated with the surface roughness of the stationary object. Therefore, the correction value for the reception level range of the exclusion area is set based on, for example, the surface roughness of the stationary object.

Specifically, in the example in FIG. 10, the correction value for the size, the correction value for the velocity, and the correction value for the radio wave reception level are set to “1.5”, “1.3”, and “0.8”, respectively, in correspondence with the type “vegetation”. The correction value for the size, the correction value for the velocity, and the correction value for the radio wave reception level are set to “0.7”, “1.3”, and “0.8”, respectively, in correspondence with the type “ornamental tree”. The correction value for the size, the correction value for the velocity, and the correction value for the radio wave reception level are set to “1.2”, “0.5”, and “1.3”, respectively, in correspondence with the type “utility pole”. The correction value for the size, the correction value for the velocity, and the correction value for the radio wave reception level are set to “1.1”, “0.6”, and “1.5”, respectively, in correspondence with the type “traffic signal”.

For example, the second determination unit 114 identifies the correction values for the size, velocity range, and the reception level range corresponding to each type of exclusion area from the correction value information 108. The second determination unit 114 multiplies the correction value for the size defined in the correction value information 108 by the initial size allocated to the corresponding exclusion candidate area, so as to determine the size of the exclusion area. Likewise, the second determination unit 114 multiples the correction value for the velocity range defined in the correction value information 108 by the initial velocity range allocated to the corresponding exclusion candidate area, so as to determine the velocity range of the exclusion area. The second determination unit 114 multiples the correction value for the reception level range defined in the correction value information 108 by the initial reception level range allocated to the corresponding exclusion candidate area, so as to determine the reception level range of the exclusion area.

Referring back to FIG. 5, the deletion unit 115 deletes an exclusion candidate area in response to a command from the user.

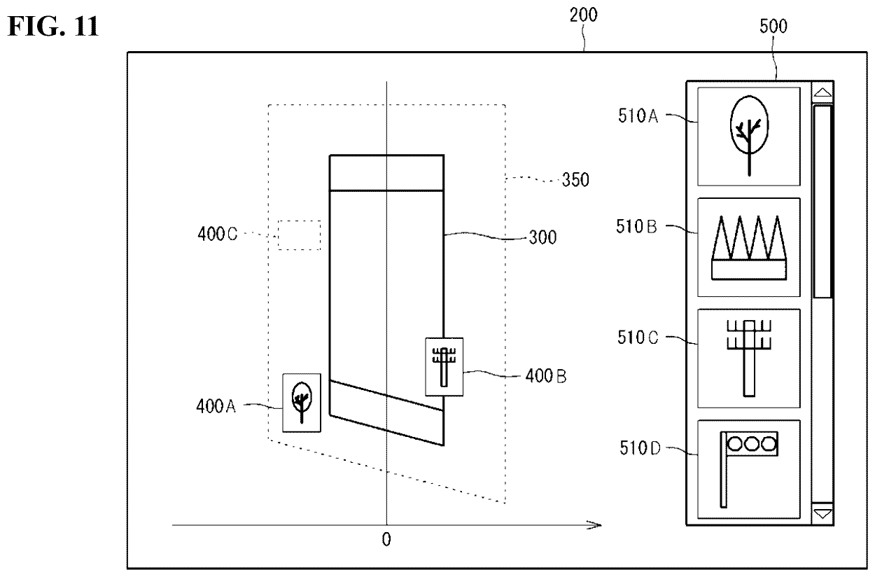

FIG. 11 illustrates a third example of the exclusion area setting screen. For example, when the exclusion candidate area 400C that is not necessary (i.e., not to be set as an exclusion area) exists, the user can use the input device 201 to designate the unnecessary exclusion candidate area 400C and to input a deletion command for the designated exclusion candidate area 400C to the setting assistance device 100. In one specific example, the user designates the exclusion candidate area 400C displayed on the screen by clicking or tapping on the exclusion candidate area 400C. The user can input the deletion command for the exclusion candidate area 400C to the setting assistance device 100 by pressing on a deletion key or touching the screen based on an operation method corresponding to a deletion.

In the example in FIG. 11, when the deletion command for the exclusion candidate area 400C is input, the deletion unit 115 deletes the exclusion candidate area 400C from the exclusion area setting screen 200.

Referring back to FIG. 5, the setting unit 116 sets the coordinate value, size, velocity range, and radio wave reception level of each of the determined exclusion areas 410A and 410B in the infrastructure radio wave sensor 10. In detail, the setting unit 116 transmits set values indicating the coordinate value, size, velocity range, and radio wave reception level of each of the determined exclusion areas 410A and 410B to the infrastructure radio wave sensor 10. The infrastructure radio wave sensor 10 stores the received set values so as to set the coordinate values, sizes, velocity ranges, and radio wave reception levels of the determined exclusion areas 410A and 410B.

### 4. Operation of Setting Assistance Device

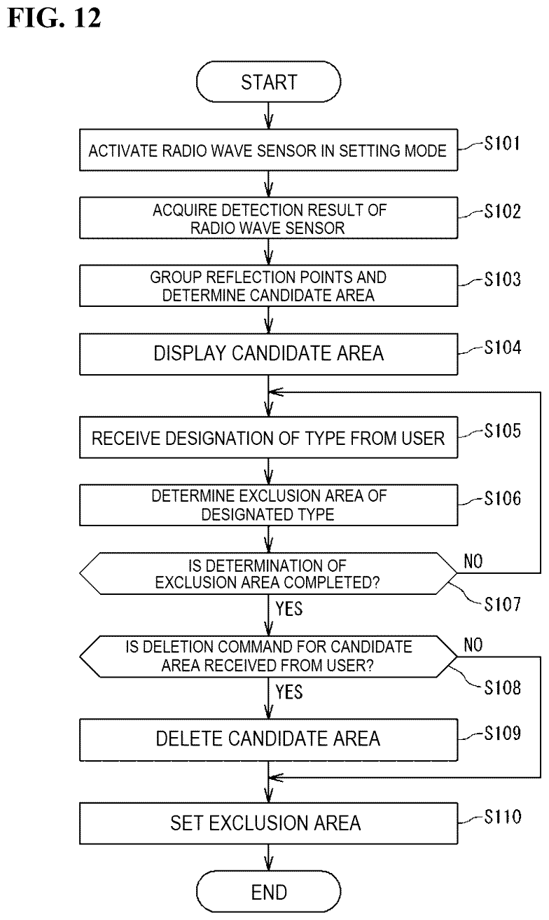

FIG. 12 is a flowchart illustrating an example of an exclusion-area setting assistance operation performed by the setting assistance device according to the embodiment.

The processor 101 of the setting assistance device 100 activates the infrastructure radio wave sensor 10 in the setting mode (step S101).

The infrastructure radio wave sensor 10 detects an object within a detection period and transmits a detection result to the setting assistance device 100. The setting assistance device 100 receives the detection result transmitted from the infrastructure radio wave sensor 10 (step S102).

The processor 101 groups reflection points included in the acquired detection result and determines the position of each formed group as an exclusion candidate area (step S103). This process involves determining exclusion candidate areas only inside the set area 350 set based on the detection area 300 and not determining exclusion candidate areas outside the set area 350.

The processor 101 causes the display device 202 to display the exclusion area setting screen 200 including the determined exclusion candidate areas (step S104). The exclusion area setting screen 200 displays the detection area 300 and the exclusion candidate areas 400A, 400B, and 400C in the sensor coordinate space.

On the exclusion area setting screen 200, the user disposes the icons 510A, 510B, 510C, and 510D in the exclusion candidate areas 400A, 400B, and 400C, so as to designate the types of exclusion areas. The processor 101 receives the designation of the types of exclusion areas from the user (step S105).

The processor 101 determines the exclusion areas 410A and 410B of the types designated by the user at the positions of the exclusion candidate areas 400A, 400B, and 400C where the icons 510A, 510B, 510C, and 510D are disposed (step S106). In this case, the processor 101 acquires, from the correction value information 108, correction values for the size, velocity range, and reception level range of the type corresponding to each of the icons 510A, 510B, 510C, and 510D (i.e., the icons 510A and 510C in the example in FIG. 10) disposed in the exclusion candidate areas 400A, 400B, and 400C. The processor 101 uses the acquired correction values to correct the initial values of the size, velocity range, and reception level range allocated to each of the exclusion candidate areas 400A and 400B, and determines the size, velocity range, and reception level range of each of the exclusion areas 410A and 410B.

The user disposes the icons 510A, 510B, 510C, and 510D in all of the exclusion candidate areas to be determined as exclusion areas. If an exclusion candidate area to be determined as an exclusion area still remains (NO in step S107), the process returns to step S105.

If the exclusion candidate area 400C that is not necessary exists on the exclusion area setting screen 200, the user can designate the exclusion candidate area 400C and input a deletion command for the designated exclusion candidate area 400C to the setting assistance device 100. When all of the exclusion areas 410A and 410B are determined (YES in step S107), the processor 101 determines whether or not a deletion command for the exclusion candidate area 400C is received from the user (step S108).

If a deletion command for the exclusion candidate area 400C is received from the user (YES in step S108), the processor 101 deletes the designated exclusion candidate area 400C from the exclusion area setting screen 200 (step S109). If a deletion command for the exclusion candidate area 400C is not received from the user (NO in step S108), the processor 101 directly proceeds to step S110.

The processor 101 sets the coordinate value, size, velocity range, and radio wave reception level of each of the determined exclusion areas 410A and 410B in the infrastructure radio wave sensor 10 (step S110). Specifically, the processor 101 transmits set values indicating the coordinate value, size, velocity range, and radio wave reception level of each of the determined exclusion areas 410A and 410B to the infrastructure radio wave sensor 10. The infrastructure radio wave sensor 10 sets the coordinate value, size, velocity range, and radio wave reception level of each of the exclusion areas 410A and 410B based on the set values. Consequently, the exclusion-area setting assistance operation ends.

### 5. Modification

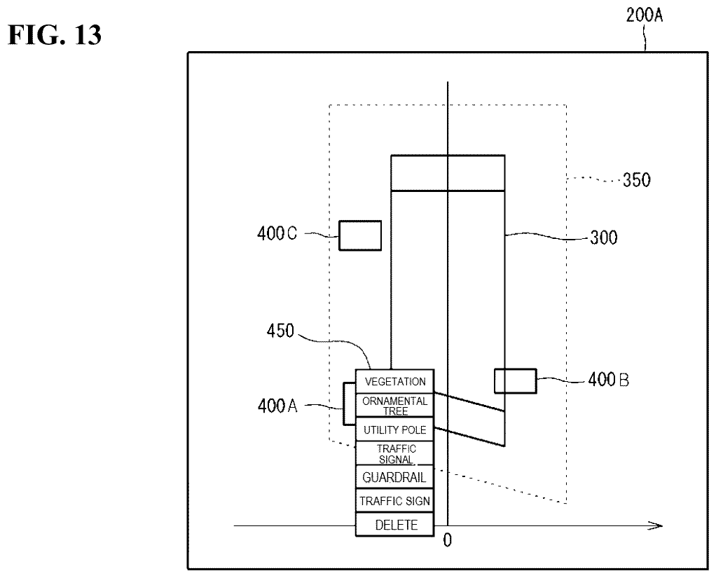

FIG. 13 is a diagram illustrating a modification of the exclusion area setting screen. An exclusion area setting screen 200A according to the modification has the icon display area 500 omitted therefrom. The exclusion area setting screen 200A can display a drop-down list 450 based on a specific operation method in each of the exclusion candidate areas 400A, 400B, and 400C being displayed. For example, the user can click or touch the exclusion candidate area 400A to display the drop-down list 450 corresponding to the exclusion candidate area 400A.

The drop-down list 450 includes items for the types of exclusion areas (vegetation, ornamental tree, utility pole, traffic signal, guardrail, and traffic sign) and a delete item. The user can designate one of the items included in the drop-down list 450 by, for example, clicking or touching, so as to input a command corresponding to the designated item to the setting assistance device 100. For example, the user can designate the item “vegetation” to input a command for determining the exclusion candidate area 400A as an exclusion area for the type “vegetation”. In another example, the user can designate the item “delete” to input a deletion command for the exclusion candidate area 400A.

The setting assistance device 100 described in the above embodiment assists in setting an exclusion area of the infrastructure radio wave sensor 10 for pedestrian detection at the crosswalk 20, but is not limited thereto. The setting assistance device may be configured to assist in setting an exclusion area of an infrastructure radio wave sensor for vehicle detection on a roadway.

### 6. Supplementary Notation

The embodiment disclosed herein is exemplary in all respects and not restrictive. The scope of the present disclosure is indicated by the claims rather than the above embodiment, and includes all modifications within the meaning and scope equivalent to the claims.

### REFERENCE SIGNS LIST

10 infrastructure radio wave sensor (radio wave sensor)
14 transmitter-receiver
15a transmitting antenna
16a receiving antenna
17 detection circuit
18 housing
18a transmitting-receiving surface
20 crosswalk
30 detection area
30A zebra zone
30B, 30C waiting zone
31P point
31Y projection center axis
31X straight line
40 radio wave irradiation area
50 structural object
51 pole
52 arm
100 setting assistance device
101 processor
102 nonvolatile memory
103 volatile memory
104 input-output interface
105 graphics controller
106 communication interface
107 setting assistance program
108 correction value information
111 acquisition unit
112 first determination unit
113 display control unit
114 second determination unit
115 deletion unit
116 setting unit
200, 200A exclusion area setting screen
201 input device
202 display device
300 detection area
300A zebra zone
300B, 300C waiting zone
350 set area
400A, 400B, 400C exclusion candidate area
410A, 410B exclusion area
450 drop-down list
500 icon display area
510A, 510B, 510C, 510D icon
G1, G2, G3, G4 group

1. A radio-wave-sensor setting assistance device comprising:
an acquisition circuitry configured to acquire a detection result obtained by a radio wave sensor detecting an object on a road;
a first determination circuitry configured to determine an exclusion candidate area in a coordinate space based on the detection result acquired by the acquisition circuitry, the exclusion candidate area being a candidate for an exclusion area to be excluded from a detection target of the radio wave sensor, the coordinate space being set in the radio wave sensor;
a display control circuitry configured to cause a display device to display the exclusion candidate area determined by the first determination circuitry; and
a second determination circuitry configured to determine, as the exclusion area, the exclusion candidate area displayed on the display device.

2. The radio-wave-sensor setting assistance device according to claim 1,
wherein the second determination circuitry determines a type of the exclusion area.

3. The radio-wave-sensor setting assistance device according to claim 2,
wherein the type is a type designated by a user.

4. The radio-wave-sensor setting assistance device according to claim 3,
wherein the display control circuitry causes the display device to display a plurality of images respectively corresponding to a plurality of types of exclusion areas, and
wherein the second determination circuitry receives designation of any of the types with respect to the exclusion area corresponding to the exclusion candidate area in response to an operation by the user for disposing any of the images in the exclusion candidate area.

5. The radio-wave-sensor setting assistance device according to claim 2,
wherein the second determination circuitry determines a size of the exclusion area in accordance with the type of the exclusion area.

6. The radio-wave-sensor setting assistance device according to claim 5,
wherein the second determination circuitry determines the size of the exclusion area corresponding to the exclusion candidate area by correcting an initial size allocated to the exclusion candidate area based on a predetermined correction value for the type.

7. The radio-wave-sensor setting assistance device according to claim 1,
wherein the second determination circuitry determines, in association with the exclusion area, at least one of a velocity range of an object to be excluded from the detection target and a radio wave reception level range of the radio wave sensor from the object to be excluded from the detection target.

8. The radio-wave-sensor setting assistance device according to claim 7,
wherein the second determination circuitry determines a magnitude of at least one of a velocity of the object and a radio wave reception level of the radio wave sensor from the object in accordance with a type determined with respect to the exclusion area.

9. The radio-wave-sensor setting assistance device according to claim 1,
wherein the first determination circuitry determines a position of the exclusion candidate area within a set area set based on a detection area set in the coordinate space, the detection area corresponding to a specific area on the road and to be detected by the radio wave sensor.

10. The radio-wave-sensor setting assistance device according to claim 1, further comprising:
a deletion circuitry configured to delete the exclusion candidate area in response to a command from a user.

11. The radio-wave-sensor setting assistance device according to claim 1,
wherein the display control circuitry causes the display device to display the exclusion candidate area together with a detection area set in the coordinate space, the detection area corresponding to a specific area on the road and to be detected by the radio wave sensor.

12. The radio-wave-sensor setting assistance device according to claim 1,
wherein the acquisition circuitry acquires the detection result obtained by the radio wave sensor detecting the object on the road within a certain detection period,
wherein the detection result indicates reflection points, on the object, of a radio wave radiated from the radio wave sensor, and
wherein the first determination circuitry groups all of the reflection points detected in the detection period based on positions of the reflection points in the coordinate space, and determines the exclusion candidate area at a position of each group.

13. A radio-wave-sensor setting assistance method comprising:
acquiring a detection result obtained by a radio wave sensor detecting an object on a road;
determining an exclusion candidate area in a coordinate space based on the acquired detection result, the exclusion candidate area being a candidate for an exclusion area to be excluded from a detection target of the radio wave sensor, the coordinate space being set in the radio wave sensor;
causing a display device to display the determined exclusion candidate area; and
determining, as the exclusion area, the exclusion candidate area displayed on the display device.

14. A non-transitory storage medium storing computer program for assisting in setting a radio wave sensor configured to detect an object on a road, the computer program causing a computer to execute a process comprising:
acquiring a detection result obtained by the radio wave sensor detecting the object on the road;
determining an exclusion candidate area in a coordinate space based on the acquired detection result, the exclusion candidate area being a candidate for an exclusion area to be excluded from a detection target of the radio wave sensor, the coordinate space being set in the radio wave sensor;
causing a display device to display the determined exclusion candidate area; and
determining, as the exclusion area, the exclusion candidate area displayed on the display device.

15. The radio-wave-sensor setting assistance device according to claim 2,
wherein the second determination circuitry determines, in association with the exclusion area, at least one of a velocity range of an object to be excluded from the detection target and a radio wave reception level range of the radio wave sensor from the object to be excluded from the detection target.

16. The radio-wave-sensor setting assistance device according to claim 3,
wherein the second determination circuitry determines, in association with the exclusion area, at least one of a velocity range of an object to be excluded from the detection target and a radio wave reception level range of the radio wave sensor from the object to be excluded from the detection target.

17. The radio-wave-sensor setting assistance device according to claim 4,
wherein the second determination circuitry determines, in association with the exclusion area, at least one of a velocity range of an object to be excluded from the detection target and a radio wave reception level range of the radio wave sensor from the object to be excluded from the detection target.

18. The radio-wave-sensor setting assistance device according to claim 5,
wherein the second determination circuitry determines, in association with the exclusion area, at least one of a velocity range of an object to be excluded from the detection target and a radio wave reception level range of the radio wave sensor from the object to be excluded from the detection target.

19. The radio-wave-sensor setting assistance device according to claim 6,
wherein the second determination circuitry determines, in association with the exclusion area, at least one of a velocity range of an object to be excluded from the detection target and a radio wave reception level range of the radio wave sensor from the object to be excluded from the detection target.

20. The radio-wave-sensor setting assistance device according to claim 15,
wherein the second determination circuitry determines a magnitude of at least one of a velocity of the object and a radio wave reception level of the radio wave sensor from the object in accordance with a type determined with respect to the exclusion area.
